(19) United States
(12) Patent Application Publication
(10) Pub. No.: US 2003/0006942 A1
(43) Pub. Date: Jan. 9, 2003

(54) Ergonomic auxiliary screen and display subsystem for portable handheld devices

(76) Inventors: Damion Searls, Portland, OR (US); Prateek Dujari, Portland, OR (US); Terrance Dishongh, Hillsboro, OR (US); Bin Lian, Hillsboro, OR (US)

Correspondence Address: MARGER JOHNSON & MCCOLLOM PC, 1030 SW MORRISON STREET, PORTLAND, OR, 97205, US

(21) Appl. No.: 09/899,520

(22) Filed: Jul. 5, 2001

(51) Int. Cl. G09G 5/00

(52) U.S. Cl. 345/1.1

(57) ABSTRACT

A portable hand-held device having a main display is provided with an auxiliary display that effectively doubles the useful viewing area. An auxiliary display video memory is allocated in memory and managed by a microprocessor within the device. The auxiliary display is either pivotally or slidingly mounted to a body portion of the device, preferably adjacent an outside edge of the main display to provide concurrent dual-display viewing and optional contiguity of displayed subject matter. A video memory management mechanism for managing the dual-display video memory in memory and for enabling pixel data to one or both of the displays may be hardware assisted, as by use of a high-speed video replay and/or rendering hardware mechanism. When not deployed for viewing, the auxiliary display folds or slides within the general confines of the body of the hand-held portable device, which may be a personal digital assistant (PDA), pocket personal computer (PC) or personal digital assistant (PDA).

### BACKGROUND OF THE INVENTION

The present invention relates generally to screens for portable handheld devices such as personal digital assistants (PDAs). More specifically, it concerns an ergonomic screen that increases the legibility, clarity and aesthetics in graphic, iconic and textual presentation.

Portable handheld devices are among the latest in a line of digital devices that extend connectivity and networking to previously uncharted limits. Rapid development in new and revolutionary technologies has imparted many features into today's portable handheld devices such as cell phones, personal digital assistants (PDAs), etc., to empower the consumer with the ability to stay continuously informed, irrespective of location. This rapid technological advancement, along with increasing demands from consumers, is expected to lead to handheld devices with capabilities far surpassing those of current PDAs. For example, PDAs now provide for world-wide web (Internet) connectivity, web browsing and even formidable personal computing. Most experts agree that the information era will further transform every aspect of how people use these devices remotely to play, work, write and read. Enormous personal, avocational and business opportunities will be spawned by the digital revolution in the form of such devices.

While technology endeavors to provide a multitude of features in a handheld device, no comparable improvement has been made in the ease of use of such devices, e.g. screen legibility. The screen size of handheld devices has been constrained while expansion of the handheld devices' capabilities has produced undesirable screen clutter, excessive scrolling requirements and busy and confusing graphics. There is an urgent need to develop an ergonomically improved display subsystem in handheld devices for more legibility, clarity and aesthetics, while accommodating a multitude of device features.

### BRIEF DESCRIPTION OF THE DRAWINGS

FIG. 1 is an isometric view of a portable handheld device featuring an ergonomic display subsystem in accordance with one embodiment of the invention.

FIG. 2 is an isometric view of an alternative embodiment of the invented portable handheld device.

FIG. 3 is a schematic block diagram of the device of FIG. 1 or 2 illustrating a screen image video memory management scheme employed by an embodiment of the invention.

FIG. 4 is a flowchart illustrating the method of the invention in one embodiment thereof.

### DETAILED DESCRIPTION OF THE INVENTION

The invention provides a novel display subsystem, e.g. an auxiliary screen and associated electronics, for handheld devices, e.g. personal digital assistants (PDAs) or cellular telephones or pocket personal computers (PCs), that provides a feasible solution for the above, thereby greatly enhancing the ergonomics for the user.

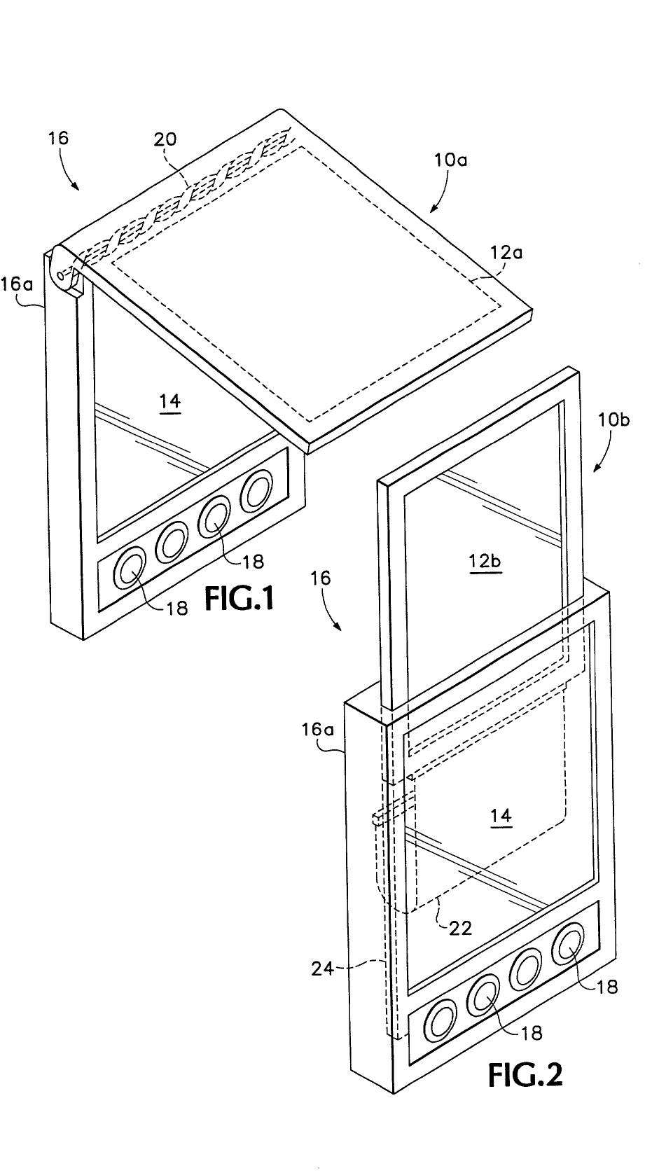

FIGS. 1 and 2 illustrate in isometric view two alternative embodiments of invented display subsystem 10, of which two different embodiments are indicated in FIGS. 1 and 2 respectively at 10a and 10b.

The invention proposes a display subsystem 10a or 10b including a movable auxiliary screen 12a or 12b (generally designated 12) in addition to the conventional main screen 14 found in otherwise conventional handheld portable device 16.

Referring briefly to FIG. 1, display subsystem 10a may be seen to include an pivotable auxiliary display 12a that folds out and opens up to provide screen area in addition to that of main display 14. Auxiliary display 12a is hinged to a body portion 16a of device 16 which will be understood typically to include a housing containing the device's electronics. This is based upon most current designs where main display 14 is in an upper region of a face of device 16. Referring briefly to FIG. 2, display subsystem 10b may be seen to include a slidable auxiliary display 12b that slides in and out of a body portion 16a of device 16, e.g. behind main display 14. Those of skill in the art will appreciate from a brief review of FIGS. 1 and 2 that auxiliary displays 12a, 12b substantially increase, e.g. approximately double or better, the available screen area in a portable handheld device.

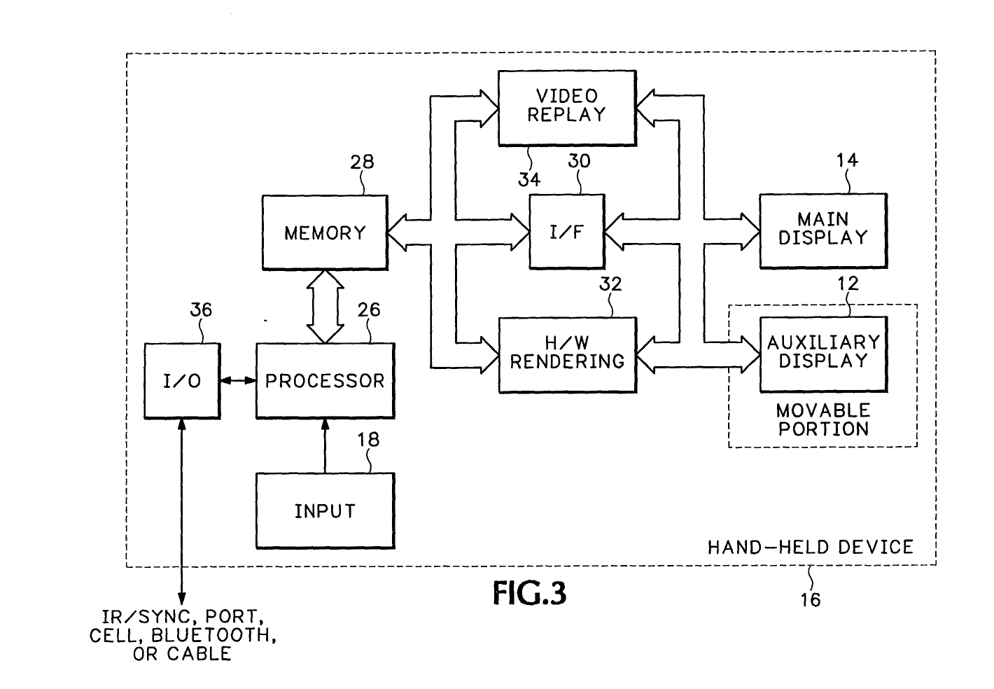

Device 16 may be seen also to include a keyboard or data entry device, indicated at 18 in FIGS. 1 and 2. Keyboard or data entry device 16 may alternatively take the form of a cursor control device such as a stylus, joystick, mouse pad or the like, effectively enabling selection by the user of one or more pushbuttons or controls. (Those of skill in the art will appreciate that the use of a stylus is typically in conjunction with a soft, or screen-rendered, keypad or menu pushbutton or icon, etc.) One or more of the keys or pushbuttons of keyboard 16 will be understood to be configured for key entry to effect pixel image displays on one or more of main display 14 or auxiliary display 12, as will be explained below by reference to FIG. 3. Within the spirit and scope of the invention, main display 14 alternatively may be a touch-screen display, which, for example, with the use of a stylus or other pointer device, effectively permits data entry or selection by the user.

Those of skill in the art will appreciate that device 16 may have an alternative form and alternative or additional features not shown in FIGS. 1 and 2. For example, device 16 may take the form of a cellular telephone or a pocket PC, and may have one or more input/output (I/O) ports for operative connection with other devices. Such I/O ports may be infrared (IR), radio frequency (RF) or any other electronic conveyance, or may include more conventional wired ports such as serial or parallel connector jacks or plugs for cables.

In one preferred embodiment of the invention, auxiliary screen 12 is used exclusively for display purposes. Thus, optional touch-screen features are constrained to main screen 14 in the body of the device. This is because pressing repeatedly on auxiliary screen 12, as would be required by a typical touch-screen, might impart undesirable cantilever forces on the hinge/joints attaching auxiliary screen 12 to body portion 16a of device 16. Such might produce reliability problems, which may be avoided.

Referring still to FIG. 1, a first embodiment of the invention is shown in which auxiliary screen 12a is hinged to pivot into and out of viewing position as needed. (FIG. 1 indicates by the use of phantom outline that the screen faces inwardly, i.e. it confronts the main screen when stowed (i.e. when the auxiliary screen is pivoted flat against the body of the hand-held device) and faces outwardly, i.e. it augments the main screen for viewing when deployed (i.e. when the auxiliary screen is pivoted away from, and preferably into parallel alignment with, the body of the hand-held device).) First, it will be appreciated that the hinged auxiliary screen 12a is made to pivot, in accordance with one embodiment of the invention, up and down. In other words, in accordance with this embodiment, the pivotal axis is horizontal relative to the handheld device (held in accordance with its intended use) and is located adjacent a top edge thereof

Those of skill in the art will appreciate, however, that, within the spirit and scope of the invention, auxiliary screen 12a may be made to attach anywhere on body portion 16a of portable handheld device 16 and to pivot around any axis relative thereto, whether vertical, horizontal or another orientation. In an exemplary alternative embodiment, the auxiliary screen may attach along a vertical side of the body portion of a portable handheld device to produce a book-style PDA having an auxiliary screen. In another exemplary alternative embodiment, the auxiliary screen may attach along a horizontal median of the body portion of a portable handheld device to produce a flip-style cell phone having an auxiliary screen.

FIG. 1 also illustrates in phantom outline—near the hinged attachment of auxiliary display 12a to body portion 16a of device 16—a helically wound ribbon cable 20 for physically enabling pixel data from a video memory within device 16 to be presented on auxiliary display 12. It will be understood that the helical winding is around an axis parallel with the axis of the hinge that pivotally mounts auxiliary display 12a to body portion 16a. Those of skill in the art will appreciate that such a helical winding of flexible ribbon cable 20 (as is used in some laptop PCs) has proven to provide reliable pixel data conveyance, high durability and long life.

While the helically wound ribbon cable configuration is described herein as representing one embodiment of the invention shown in FIG. 1, alternative interconnection schemes are contemplated. For example, those of skill in the art will appreciate that a nominally flat ribbon cable may be used to provide the needed input/output (PO) interconnection between pixel data memory and the auxiliary display. Such an alternative flat ribbon cable arrangement is shown in FIG. 2 to be described below. (It will be appreciated that a flat ribbon cable, as used in pivotable auxiliary display 12a of FIG. 1, would tend also to curve or spiral around the hinge axis as the display is pivoted between its deployed and stowed positions. Thus, such an alternative embodiment also is referred to herein as a spiral wound cable configuration.) Preferably, the design of the interconnection takes into account cost, bandwidth, and durability considerations. (For example, it is preferred that the cable provide adequate strain relief when flexed, i.e. when the pivotable auxiliary display of FIG. 1 is stowed or when the slidable auxiliary display of FIG. 2 is deployed. It also is preferred that the cable not cause interference when relaxed, i.e. when the pivotable auxiliary display of FIG. 1 is deployed or when the slidable auxiliary display of FIG. 2 is stowed.) Preferred embodiments thus are flat, spiral or helical ribbon cables dimensioned and configured (like the helical ribbon cable illustrated in FIG. 1 and like the flat ribbon cable illustrated in FIG. 2) to flex without undue strain or slack during pivotal movement of auxiliary display 12a between its stowed and deployed positions. Any suitable interconnection means is within the spirit and scope of the invention.

Preferably, main and auxiliary displays 12 and 14 are low-cost, high-performance flat panel displays such as electro-luminescent or liquid crystal displays (LCDs) or other suitable technology. Preferably, of course, to maintain a slender profile and substantially confine the auxiliary display within the perimeter of the hand-held device, at least when the auxiliary display is in its stowed position, both the main and auxiliary displays are of a thin, flat panel type. Displays 12 and 14 alternatively may operate at a lower performance level or be of higher cost, within the spirit and scope of the invention.

FIG. 2 shows a second, alternative embodiment of the invented display subsystem in which auxiliary screen 12b slides into and out of the body portion 16a, e.g. the housing, of handheld device 16 as needed. It may be seen from FIG. 2 that a preferably flat, flexible ribbon cable 22 is used to route pixel data and address information form the display video memory to the main and auxiliary displays. Ribbon cable 22 preferably extends as illustrated between the top edge of main display 14 to the bottom edge of auxiliary display 12. This will be understood to minimize the path taken by the ribbon cable and simplify routing thereof. Those of skill in the art will appreciate that auxiliary display 12 preferably slides into a longitudinal slot 24 formed within device 16 behind main screen 14. Ribbon cable 22 may be routed through internal guides affixed therein, and when auxiliary display 12 is deployed for viewing, as illustrated in solid lines in FIG. 2, it preferably is disposed through a substantially 180° turn within the body of device 16. When auxiliary display 12 is stowed within the body of device 16 (as indicated in phantom in FIG. 2 by dashed lines) ribbon cable 22 will be understood preferably to lie flat against the face of auxiliary display 12 within slot 24.

FIG. 3 illustrates a screen video memory management scheme by which the display subsystems' alternative embodiments find particular utility. Specifically, the schematic block diagram shows that device 16 includes a microprocessor 26 and a memory 28 including first and second video memories representing contiguous blocks of memory for main display 14 and relatively movable auxiliary display 12. It also includes an interface (I/F) 30 therebetween for enabling pixel data from the display video memories to the displays; an optional hardware (H/W) rendering mechanism 32 for reading data from the video memories and mapping them to the screens; and an optional high-speed (streaming) video replay mechanism 34 for high-speed, hardware-assisted loading of pixel data video memory. It also includes a user input device or mode control mechanism, e.g. keyboard 18, operable to control the configuration of the pixel data within the dual-screen video memory.

It will be appreciated that interface 30, hardware rendering mechanism 32 and video replay mechanism 34 may be provided, within the spirit and scope of the invention, in the alternative or in any suitable combination, depending upon the desired functionality and cost goals.

Interface 30 is used herein to describe any interface that conveys pixel data signals from memory 28 to main and auxiliary displays 14, 12, whether high- or low-performance and whether high- or low-cost. Thus, interface refers broadly to any video bus and wiring scheme, such as those used in laptop PCs or currently available PDAs or pocket PCs.

Hardware rendering mechanism 32 is used to describe any suitable hardware assistance mechanism that increases the bandwidth, refresh speed, graphic capability or performance aesthetics of the main or auxiliary display. In other words, hardware rendering mechanism 32 may act as a graphic processing unit (GPU) that performs video co-processing functions concurrent with normal processing by processor 26.

Video replay mechanism 34 is used to describe any high-speed video mechanism that increases the overall video bandwidth between memory and the main or auxiliary displays 14, 12. Such may be useful in rendering television-quality motion picture monitoring capability to hand-held portable device 16.

Those of skill in the art will appreciate that I/O signal routing from memory 28 to auxiliary display 12 may be dependent upon, i.e. slaved to, that of the I/O signal routing to main memory 14 (as suggested in FIGS. 1 and 2), or that it may be entirely independent therefrom (as suggested in FIG. 3). In other words, auxiliary display 12 need not ‘piggy back’ on main display 14, but instead may have its own physical and logical pixel data access to memory 28. The routing of pixel data from memory to one or more displays may take any suitable form, within the spirit and scope of the invention. Signal routing or layout density problems may be avoided by increasing the signaling layers in a printed circuit board (PCB) that mounts the memory and routes such signals via I/O pins to the displays, by time-multiplexing the pixel data routed to the displays over fewer signal lines.

For example, the video bus between main and auxiliary displays may be timeduplexed. Or one or the other of the video buses driving the displays may themselves be time-multiplexed (thereby to reduce I/O signal count by a desirable factor). Other suitable techniques for increasing the effective I/O density are contemplated, although it is appreciated that typically such techniques may reduce I/O bandwidth.

Finally, device 16 may include an external I/O section 36 operatively coupled with microprocessor 26 for providing any input/output options, e.g. flash memory, serial or parallel port, etc. Such I/O control and physical I/O ports may be of conventional design and utility. For example, a satellite antenna and transmitter/receiver may be provided in case portable, hand-held device 16 takes the form of a cellular telephone. Or, an I/R or edge connector hot sync port may be provided in case portable, hand-held device 16 takes the form of a portable PC or PDA. Other optional features and communication functions are contemplated, and are within the spirit and scope of the invention.

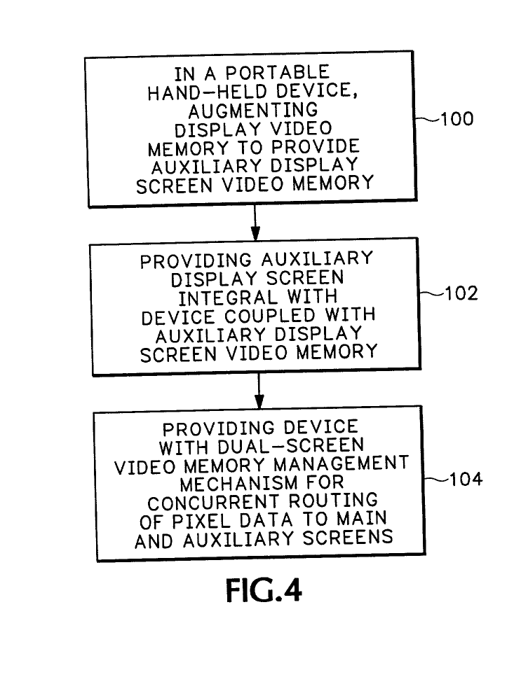

The method of the invention now may be understood by reference to FIG. 4. The method preferably includes 100) in a portable, hand-held device augmenting display video memory to provide an auxiliary display video memory. The method also preferably includes 102) providing an auxiliary display integral with the device and coupled with the auxiliary video memory. Finally, the method preferably includes 104) providing the device with a dual-screen video memory management mechanism for concurrent routing of pixel data to the main and auxiliary displays. Preferably, the auxiliary display is movably, e.g. pivotally or slidably, mounted for deployment or stowage to a body portion of the portable, hand-held device.

Finally, those of skill in the art will appreciate that the invented method and apparatus described and illustrated herein may be implemented in software, firmware or hardware, or any suitable combination thereof. Preferably, the method and apparatus are implemented in a combination of hardware and firmware, for purposes of low cost and flexibility. Thus, those of skill in the art will appreciate that parts of the method and apparatus of the invention may be implemented by a computer or microprocessor process in which instructions are executed, the instructions being stored for execution on a computer-readable medium and being executed by any suitable instruction processor. Alternative embodiments are contemplated, however, and are within the spirit and scope of the invention.

Having illustrated and described the principles of our invention in a preferred embodiment thereof, it should be readily apparent to those skilled in the art that the invention can be modified in arrangement and detail without departing from such principles. We claim all modifications coming within the spirit and scope of the accompanying claims.

1. A display subsystem for a portable handheld device comprising:
a main display screen configured for fixed mounting to a housing of a portable handheld device;
an auxiliary display screen configured for movable mounting to the housing; and
a display screen drive mechanism including
a dual-screen video memory, and
an interface between said memory and said main screen and between said memory and said auxiliary display screen,
said interface adapted to enable pixel data from a first segment of said video memory to be presented on said main display screen and to enable pixel data from a second segment of said video memory to be presented concurrently on said auxiliary display screen.

2. The display subsystem of claim 1, wherein said interface selectively enables pixel data from said second segment of said video memory to be presented on said auxiliary display screen.

3. The display subsystem of claim 1, wherein said auxiliary display screen is mounted to the housing for pivotal movement relative to said main display screen.

4. The display subsystem of claim 3, wherein said interface between said memory and said auxiliary display screen includes a spirally or helically wound flexible ribbon cable to physically enable the pixel data from the second segment of said video memory to be presented on said auxiliary display screen.

5. The display subsystem of claim 1, wherein said auxiliary display screen is mounted to the housing for sliding movement relative to said main display screen between a first stowed position substantially within the housing and a second deployed position substantially external thereto.

6. The display subsystem of claim 5, wherein said interface between said memory and said auxiliary display screen includes a flexible ribbon cable to physically enable the pixel data from the second segment of said video memory to be presented on said auxiliary display screen, the flexible ribbon cable disposed along a serpentine path within the housing when said auxiliary display screen is in the first stowed position within the housing and the flexible ribbon cable disposed along a substantially linear path within the housing when said auxiliary display screen is in the second deployed position external to the housing.

7. The display subsystem of claim 1, wherein said dual-screen video memory is configured to store pixel data in said first and second segments thereof representing a substantially contiguous display to be presented on said main display and said auxiliary display.

8. The display subsystem of claim 1, which further comprises:
a user input mode control mechanism operable to control whether said first and second segments of said dual-screen video memory stores pixel data representing a substantially contiguous or substantially discontiguous display to be presented on said main display and said auxiliary display.

9. The display subsystem of claim 1, wherein said auxiliary display screen is movably but substantially inseparably mounted to the housing.

10. The display subsystem of claim 1, wherein said auxiliary display screen is intimately physically attached to the housing.

11. The display subsystem of claim 1, wherein said interface includes a high-speed video replay mechanism to couple at least one of said main display screen and said auxiliary display screen to a respective one of said first and second segments of said video memory.

12. The display subsystem of claim 1, wherein said interface includes a hardware rendering mechanism to couple at least one of said main display screen and said auxiliary display screen to a respective one of said first and second segments of said video memory.

13. The display subsystem of claim 1, wherein said auxiliary display screen is a flat panel.

14. The display subsystem of claim 1, wherein said auxiliary display screen is mounted to the housing in a configuration such that an edge of the auxiliary screen is adjacent an edge of the main screen.

15. A portable handheld device comprising:
a housing configured as a part of a body of the handheld device;
a main display fixedly mounted within the body of the device;
an auxiliary display movably mounted to the body of the device, the auxiliary display manually selectively deployable for viewing;
a processor contained within the housing to manage a screen video memory;
a screen video memory contained within the housing, the memory operatively connected to said processor, the memory including a screen image video memory to store pixel data for said main display and a screen image video memory to store pixel data for said auxiliary display; and
a keyboard operatively connected to said processor, said keyboard mounted on an exterior face of the housing, the keyboard configured for key entry to effect pixel image displays on one or more of said main display and said auxiliary display.

16. The device of claim 15, wherein said auxiliary display is pivotably mounted on the housing.

17. The device of claim 15, wherein said auxiliary display is slidably mounted on the housing.

18. The device of claim 17, wherein said auxiliary display is slidable for stowage to an interior of the housing, and wherein said auxiliary display is slidable to deploy the same to an exterior of the housing for viewing.

19. The device of claim 15 which further comprises an interface between said memory and said main display and between said memory and said auxiliary display, wherein said interface between said memory and said auxiliary display includes a spirally or helically wound flexible ribbon cable to physically enable the pixel data from the screen image video memory to store pixel data for said auxiliary display to be presented on said auxiliary display.

20. The display subsystem of claim 15, wherein said auxiliary display is mounted to the housing to slide relative to said main display between a first stowed position substantially within the body of the device and a second deployed position substantially external thereto.

21. The display subsystem of claim 15 which further comprises an interface between said memory and said main display and between said memory and said auxiliary display, wherein said interface between said memory and said auxiliary display includes a flexible ribbon cable to physically enable the pixel data from the screen image video memory to store pixel data for said auxiliary display to be presented on said auxiliary display, the flexible ribbon cable disposed through a substantially 180° turn within the body of the device when said auxiliary display is in a first stowed position within the body and the flexible ribbon cable disposed along a substantially linear path within the body when said auxiliary display is in a second deployed position external to the housing.

22. The display subsystem of claim 15, wherein said dual-screen video memory stores pixel data in said first and second segments thereof to represent a substantially contiguous display to be presented on said main display and said auxiliary display.

23. The device of claim 15 which further comprises:
a high-speed video replay mechanism operatively coupled between at least one of said main display and said auxiliary display to a respective one of said screen image video memories.

24. The device of claim 15 which further comprises:
a hardware rendering mechanism operatively coupled between at least one of said main display and said auxiliary display to a respective one of said screen image video memories.

25. The device of claim 15, wherein said auxiliary display includes a flat panel.

26. The device of claim 15, wherein said auxiliary display is mounted to the housing in such a configuration that an edge of the auxiliary screen is adjacent an edge of the main screen.

27. A method of augmenting the effective capacity of a display subsystem integral with a portable handheld device having a display video memory and a main display, the method comprising:
augmenting the display video memory to provide an auxiliary display video memory;
providing an auxiliary display integrally connected with the device and operatively coupled with the auxiliary display video memory; and
providing the device with a dual-display video memory management mechanism to concurrently route pixel data from the main and auxiliary display video memories to the main and auxiliary displays.

28. The method of claim 27, wherein said providing of the auxiliary display is performed such that the auxiliary display is movably mounted to a body portion of the device.

29. The method of claim 28, wherein said providing of the auxiliary display is performed such that the auxiliary display is pivotably or slidably mounted to a body portion of the device adjacent an edge of the main display.

30. The method of claim 29 which further comprises:
providing a flexible cable extending between an outside edge of the main display and an inside edge of the auxiliary display to route pixel data therebetween.
